(19) United States
(12) Patent Application Publication
(10) Pub. No.: US 2014/0176548 A1
(43) Pub. Date: Jun. 26, 2014

(54) FACIAL IMAGE ENHANCEMENT FOR VIDEO COMMUNICATION

(71) Applicant: NVIDIA CORPORATION, Santa Clara, CA (US)

(72) Inventor: Simon Green, London (GB)

(73) Assignee: NVIDIA CORPORATION, Santa Clara, CA (US)

(21) Appl. No.: 13/724,590

(22) Filed: Dec. 21, 2012

(51) Int. Cl. G06T 5/00; G06T 15/04; G06K 9/00

(52) U.S. Cl. CPC G06T 5/00; G06K 9/00268; G06T 15/04
USPC 345/426; 382/254; 382/199; 382/264; 345/420

(57) ABSTRACT

A facial image enhancement system includes a deformable face tracker that provides a tracked face model from a facial video stream. Additionally, the facial image enhancement system includes a face enhancement image processing engine that uses the tracked face model to process the facial video stream, wherein an image enhancement of the facial video stream provides an enhanced facial video stream. A facial image enhancement method is also provided.

### TECHNICAL FIELD

This application is directed, in general, to video processing and, more specifically, to a facial image enhancement system and a facial image enhancement method.

### BACKGROUND

Videotelephony, including videoconferencing and webcam usage, is an increasingly popular communication method between people in real-time (e.g., 15 display frames per second or greater) that employs technologies for the reception and transmission of audio-video signals by users at different locations. Its usage has made significant inroads in government, healthcare and education as well the use of video chat (e.g., Skype and Facetime). The introduction of a video component has increased an awareness of the importance of how a participant actually looks during the communication and may actually inhibit or restrict this form of usage under certain conditions.

### SUMMARY

Embodiments of the present disclosure provide a facial image enhancement system and a facial image enhancement method.

In one embodiment, the facial image enhancement system includes a deformable face tracker that provides a tracked face model from a facial video stream. Additionally, the facial image enhancement system includes a face enhancement image processing engine that uses the tracked face model to process the facial video stream, wherein an image enhancement of the facial video stream provides an enhanced facial video stream.

In another aspect, the facial image enhancement method includes providing a facial video stream and providing a tracked face model from the facial video stream. The facial image enhancement method also includes processing the facial video stream with an image enhancement of the tracked face model to provide an enhanced facial video stream.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

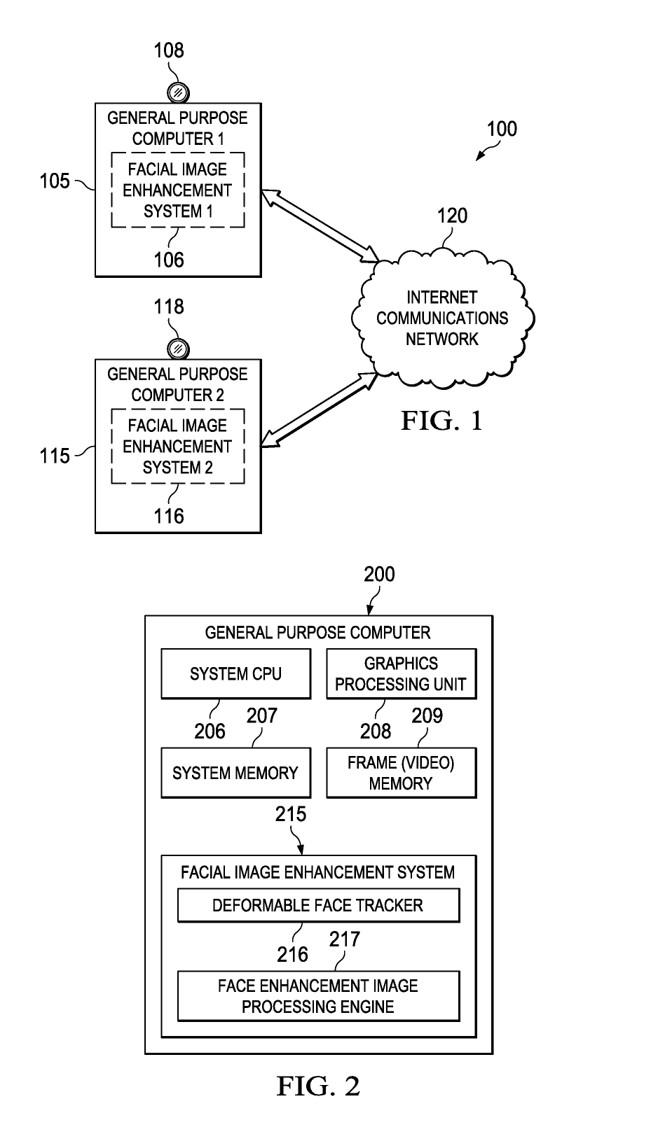

FIG. 1 illustrates a diagram of an embodiment of an Internet arrangement constructed according to the principles of the present disclosure;

FIG. 2 illustrates a block diagram of a general purpose computer constructed according to the principles of the present disclosure;

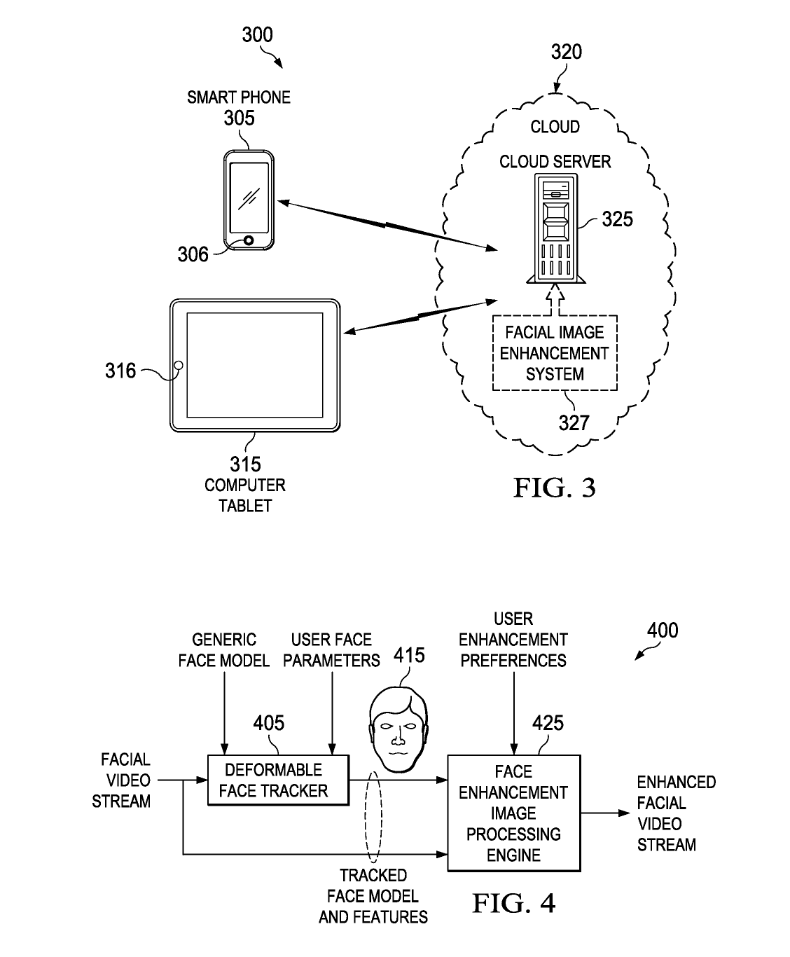

FIG. 3 illustrates a diagram of an embodiment of a cloud arrangement constructed according to the principles of the present disclosure;

FIG. 4 illustrates an embodiment of a facial image enhancement system constructed according to the principles of the present disclosure; and

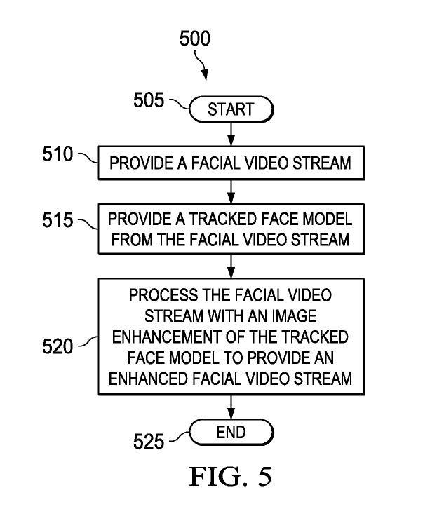

FIG. 5 illustrates a flow diagram of an embodiment of a facial image enhancement method carried out according to the principles of the present disclosure.

### DETAILED DESCRIPTION

Embodiments of the present disclosure provide a real-time enhancement of a facial image that is based on a tracked face model. The tracked face model is employed to identify regions of a face on a video stream that are enhanced to provide an enhanced facial video stream. For the purposes of this disclosure, the term “enhancement” as applied to a face is defined to mean a beautification or embellishment of facial features. Adornments such as jewelry or eye glasses may also be included.

FIG. 1 illustrates a diagram of an embodiment of an Internet arrangement, generally designated 100, constructed according to the principles of the present disclosure. The Internet arrangement 100 includes first and second general purpose computers 105, 115 and an Internet communications network 120. The first and second general purpose computers 105, 115 are linked to one another through the Internet communications network 120, as shown. The first general purpose computer 105 includes a first image enhancement system 106 that is employed with a first video camera 108. The second general purpose computer 115 includes a second image enhancement system 116 that is employed with a second video camera 118.

The first and second general purpose computers 105, 115 may be representative of desktop, laptop or notebook computer systems. As such, the first and second general purpose computers 105, 115 operate as thick clients connected to the Internet communications network 120. Additionally, the first and second general purpose computers 105, 115 provide their own local display rendering information.

The first image enhancement system 106 provides a first enhanced facial video stream from the first general purpose computer 105 for transmission through the Internet communications network 120 and display on the second general purpose computer 115. Correspondingly, the second image enhancement system 116 provides a second enhanced facial video stream from the second general purpose computer 115 for transmission through the Internet communications network 120 and display on the first general purpose computer 105. Each of these enhanced facial video streams may be displayed during a video chat session, for example.

FIG. 2 illustrates a block diagram of a general purpose computer, generally designated 200, constructed according to the principles of the present disclosure. In the illustrated embodiment, the general purpose computer 200 may be employed as the first and second general purpose computers of FIG. 1. The general purpose computer 200 includes a system central processing unit (CPU) 206, a system memory 207, a graphics processing unit (GPU) 208 and a frame memory 209. The general purpose computer 200 also includes a facial image enhancement system 215.

The system CPU 206 is coupled to the system memory 207 and the GPU 208 and provides general computing processes and control of operations for the local computer 105. The system memory 207 includes long term memory storage (e.g., a hard drive) for computer applications and random access memory (RAM) to facilitate computation by the system CPU 206. The GPU 208 is further coupled to the frame memory 209 and provides monitor display and frame control of a local monitor. Additionally, the GPU 208 and the frame memory 209 provide a user facial video stream supplied by an associated camera (such as a web camera) that is supplied to the facial image enhancement system 215 for further processing.

The facial image enhancement system 215 is generally indicated in the general purpose computer 200, and in one embodiment is a software module. As such, the facial image enhancement system 215 may operationally reside in the system memory 207, the frame memory 209 or in portions of both. Alternately, the facial image enhancement system 215 may be implemented as a hardware unit, which is specifically tailored to enhance computational throughput speeds for the facial image enhancement system 215. Of course, a combination of these two approaches may be employed.

The facial image enhancement system 215 is coupled within the general purpose computer 200 to provide an enhanced facial video stream from the user facial video stream provided to the facial image enhancement system 215. As may be seen in FIG. 2, the facial image enhancement system 215 includes a deformable face tracker 216 and a face enhancement image processing engine 217. The deformable face tracker 216 provides a tracked face model from the facial video stream. Additionally, the face enhancement image processing engine uses the tracked face model to process the facial video stream, wherein an image enhancement of the facial video stream provides an enhanced facial video stream. The enhanced facial video stream is typically provided as a video encoded stream.

FIG. 3 illustrates a diagram of an embodiment of a cloud arrangement, generally designated 300, constructed according to the principles of the present disclosure. The cloud arrangement 300 includes first and second user devices 305, 315 and a cloud network 320 employing a cloud server 325. The first and second user devices 305, 315 are thin clients.

Generally, a thin client is a dedicated device (in this case, a user device) that depends heavily on a server to assist in or fulfill its traditional roles. The thin client may incorporate a computer having limited capabilities (compared to a standalone computer) and one that accommodates only a reduced set of essential applications. Typically, the thin client computer system is devoid of optical drives (CD-ROM or DVD drives), for example. The thin client depends on a central processing server, such as the cloud server 325, to function operationally. In the illustrated example of the cloud arrangement 300, the first and second user devices 305, 315 are respectively a cell phone and a computer tablet (i.e., a tablet) having touch sensitive screens and associated cameras 306, 316 capable of generating a user facial video stream. Of course, other embodiments may employ standalone computers systems (i.e., thick clients) although they are generally not required.

In the illustrated embodiment of FIG. 3, the cloud server 325 is a general purpose computer employing a facial image enhancement system such as the general purpose computer 200 discussed with respect to FIG. 2. Display rendering information for each display frame is processed and provided by the cloud server 325 and streamed to each of the first and second user devices (i.e., the cell phone 305 and the computer tablet 315). Additionally, the facial image enhancement system sends an enhanced facial video stream to the second user device 315 based on a user facial video stream from the first user device 305. Correspondingly, the facial image enhancement system also sends an enhanced facial video stream to the first user device 305 based on a user facial video stream from the second user device 315.

FIG. 4 illustrates an embodiment of a facial image enhancement system, generally designated 400, constructed according to the principles of the present disclosure. The facial image enhancement system includes a deformable face tracker 405 that produces a tracked face model 415 and a face enhancement image processing engine 425. The increasing resolution and depth capabilities of front-facing cameras can provide depth values for each display pixel and allow higher quality tracking and separation of a face from a background.

The deformable face tracker 405 employs a tracking algorithm that is capable of tracking a face in real-time. A deformable face tracking technique (e.g., active appearance models) tracks features in the face and generates an animated two dimensional (2D) or three dimensional (3D) model which accurately follows the motion of the face in the video.

Ideally, the deformable face tracker 405 provides sub-pixel resolution, since single pixel resolution indicates that only integer coordinates are generated in the tracked face model. If the eyes of the tracked face model image are only 10 by 10 pixels wide, enhancement of the eye image would jump from pixel to pixel thereby not accurately matching the original eyes in the video stream. Sub-pixel resolution of eye tracking improves this condition.

Face tracking performance can be improved using user-specific training, which typically involves performing a series of facial expressions in front of the camera. This allows the system to more accurately capture the users face shape. User-specific data obtained in this way can be stored for each user and refined over time.

The face enhancement image processing engine 425 provides specific image enhancements to the tracked face model 415. These enhancements may employ use of mask images or filters and include the following. Background removal or replacement may leave the tracked face model 415 hanging in space, for example. Alternately, a black or other colored background or a static image of some kind can replace an existing background. A mask image may be created to separate the face from the background.

A skin smoothing enhancement may be provided employing an edge-preserving filter (e.g., a bilateral filter, which is a class of edge-preserving filters). This may be part of image processing where an image is smoothed while maintaining the edge of the image. Blemish removal may also be accomplished (e.g., using in-painting techniques). In-painting techniques take colors and texture from surrounding areas and use them to paint inside a surrounded area. They may be used in removing warts, moles, scars, etc. Additionally, make up may be applied employing some of the same approaches above to remove skin blotches.

The tracked face model 415 provides an outline or image of the eyes, where the brightness and contrast of the image may be scaled up (i.e., enhanced) to increase the whiteness of the area around the iris of the eye. Since typically only the existing white area needs to be enhanced, this process may require a color comparison within the eye to identify or separate the white area. Correspondingly, teeth whitening may employ the same or similar approaches as the eye highlighting above, since an outline or image of the mouth is also provided from the tracked face model 415. In addition, color correction filters can be applied to change the color of eyes or skin. Augmentation such as eye glasses or jewelry may be added to provide a different “look” as desired.

A basic idea employed in the facial image enhancement system 400 is to provide preselected parameters that are stored (perhaps by each user of the imaging equipment) and then recalled at the time of use. There may be a catalog or listing of these parameters (corresponding to the filters mentioned earlier) and a user may employ a checkbox to select the desired enhancements, for example.

As noted above, the tracked face model 415 may be used to generate 2D or 3D image masks (also known as mattes), which track the regions of the face (skin, eyes, mouth etc.). These masks are used to apply specific image filters to specific face regions. For example, an image mask may be one that provides a white area for the eyes, with black surrounding elsewhere. Ideally, these mask images are anti-aliased, meaning that they provide smooth edges. Additionally, the masks may further be “feathered”, meaning that the effect of the filter is reduced towards the edge of a feature region.

Specific image processing filters may be applied to specific image regions for each frame of the video. Employing a facial video stream, graphics hardware (e.g., a GPU graphics pipeline) may be used to provide image processing operations. From the deformable face tracker 405, a 3D model that is a list of vertices in 3D space having positions designated for triangles may be obtained, for example. The 3D model pertaining to the tracked face model 415 is constructed from a list of points and then a list of triangles that join together these points.

In addition, 3D models can be rendered on top of a video stream using the 3D tracked face model 415 to generate accurate occlusion information. Since 3D modeling is often done with triangles, texturing mapping may be employed to apply images to the triangles and actually render the 3D model by using a video image as a texture. A shader program may actually calculate whatever image filter that is being applied. For a skin smoothing example, a shader program may be employed that reads the neighboring pixels and then averages them in some predetermined manner to calculate a final color.

The face enhancement image processing engine 425 may also estimate from the imagery and provide a direction, color and distribution of the incident lighting in a display scene. This estimate may then be used to improve the realism of the image processing, and to light any synthetic 3D models added to the scene. Light direction may be estimated from the gradient of intensity on the tracked face model 415, for example. The face enhancement image processing engine 425 may then analyze to determine the direction from which the light originates and the color of the light. An environment map may be created or employed to describe the environment in all directions. Additionally, a failsafe feature provides for showing the last successfully processed image for the case of a system failure.

FIG. 5 illustrates a flow diagram of an embodiment of a facial image enhancement method, generally designated 500, carried out according to the principles of the present disclosure. The method 500 starts in a step 505 and a facial video stream is provided in a step 510. Then, a tracked face model is provided from the facial video stream in a step 515, and the facial video stream is processed with an image enhancement of the tracked face model to provide an enhanced facial video stream, in a step 520.

In one embodiment, the image enhancement is processed in real time. In another embodiment, the image enhancement employs an image mask that identifies specific regions in a face image. Correspondingly, the image mask includes a feathered region resulting in a fade out or blended region at a feature region edge. In yet another embodiment, the image enhancement employs an edge-preserving blur or smoothing filter. In still another embodiment, the image enhancement employs an in-painting technique. In a further embodiment, the image enhancement employs preselected parameters that are provided for selection. Correspondingly, the preselected parameters are provided in a catalog or listing for selection.

In a yet further embodiment, a three dimensional model pertaining to the tracked face model is constructed from a list of points and a list of triangles that join together these points. Correspondingly, texturing mapping using a video image as a texture is applied to the list of triangles to render the three dimensional model. In a still further embodiment, a shader program calculates an image filter that averages a group of neighboring pixels to calculate a final color. The method 500 ends in a step 525.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A facial image enhancement system, comprising:
a deformable face tracker that provides a tracked face model from a facial video stream; and
a face enhancement image processing engine that uses the tracked face model to process the facial video stream, wherein an image enhancement of the facial video stream provides an enhanced facial video stream.

2. The system as recited in claim 1 wherein the image enhancement is processed in real time.

3. The system as recited in claim 1 wherein the image enhancement employs an image mask that identifies specific regions in a face image.

4. The system as recited in claim 3 wherein the image mask includes a feathered region resulting in a fade out or blended region at a feature region edge.

5. The system as recited in claim 1 wherein the image enhancement employs an edge-preserving blur or smoothing filter.

6. The system as recited in claim 1 wherein the image enhancement employs an in-painting technique.

7. The system as recited in claim 1 wherein the image enhancement employs preselected parameters that are provided for user selection.

8. The system as recited in claim 7 wherein the preselected parameters are provided in a catalog or listing for selection.

9. The system as recited in claim 1 wherein a three dimensional model pertaining to the tracked face model is constructed from a list of points and a list of triangles that join together these points.

10. The system as recited in claim 9 wherein texturing mapping using a video image as a texture is applied to the list of triangles to render the three dimensional model.

11. The system as recited in claim 1 wherein a shader program calculates an image filter that averages a group of neighboring pixels to calculate a final color.

12. A facial image enhancement method, comprising:
providing a facial video stream;
providing a tracked face model from the facial video stream; and
processing the facial video stream with an image enhancement of the tracked face model to provide an enhanced facial video stream.

13. The method as recited in claim 12 wherein the image enhancement is processed in real time.

14. The method as recited in claim 12 wherein the image enhancement employs an image mask that identifies specific regions in a face image.

15. The method as recited in claim 14 wherein the image mask includes a feathered region resulting in a fade out or blended region at a feature region edge.

16. The method as recited in claim 12 wherein the image enhancement employs an edge-preserving blur or smoothing filter.

17. The method as recited in claim 12 wherein the image enhancement employs an in-painting technique.

18. The method as recited in claim 12 wherein the image enhancement employs preselected parameters that are provided for selection.

19. The method as recited in claim 18 wherein the preselected parameters are provided in a catalog or listing for selection.

20. The method as recited in claim 12 wherein a three dimensional model pertaining to the tracked face model is constructed from a list of points and a list of triangles that join together these points.

21. The method as recited in claim 20 wherein texturing mapping using a video image as a texture is applied to the list of triangles to render the three dimensional model.

22. The method as recited in claim 12 wherein a shader program calculates an image filter that averages a group of neighboring pixels to calculate a final color.
